(19) United States
(12) Patent Application Publication
(10) Pub. No.: US 2008/0183331 A1
(43) Pub. Date: Jul. 31, 2008

(54) Semiconductor process tool

(76) Inventor: Jih-Hsien Yeh, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/669,896

(22) Filed: Jan. 31, 2007

(51) Int. Cl. G05B 19/418; G06F 17/00

(52) U.S. Cl. 700/248; 700/213; 901/31

(57) ABSTRACT

A semiconductor process tool comprises two or more wafer stages for separately receiving wafers carrying or not carrying contaminating material. The semiconductor process tool may further comprise two rot arms, load ports, and two chucks separately used for the wafers. The wafers carrying or not carrying contaminating material can be processed in a same process unit but through different stages, robots, and load ports, that is, different paths, without suffering from cross contamination.

### BACKGROUND OF THE INVENTION

1. Field of the Invention

The present invention relates generally to semiconductor fabrication technology, and, more particularly, to a semiconductor process tool using separated wafer stages for wafers carrying contaminating or non-contaminating material.

2. Description of the Prior Art

In the process of forming integrated circuit devices, millions of transistors are formed above a semiconductor substrate. In general, semiconductor manufacturing operations involve, among other things, the formation of layers of various materials, e.g., polysilicon, insulating materials, metals, etc., and the selective removal of portions of those layers by performing known photolithographic and etching techniques. These processes, along with various ion implant and heating processes, are continued until the integrated circuit device is complete. Additionally, a typical integrated circuit device is comprised of a plurality of conductive interconnections, such as conductive lines and conductive contacts or vias, positioned in multiple layers of insulating material formed above the substrate. These conductive interconnections allow electrical signals to propagate between the transistors formed above the substrate.

Generally, a set of processing steps is performed on a group of wafers using a variety of processing tools, including photolithography steppers, etch tools, deposition tools, polishing tools, rapid thermal processing tools, implantation tools, and the like. Furthermore, due to the demand for faster, more reliable and higher performing semiconductors, inspection tools are necessary to increase yields. Most current inspection tools are designed for a specific single type of inspection, metrology or review such as any one of the following: two dimensional front side, three dimensional front side, edge, back side, review, metrology, wafer bowing, microscopy and the like, and are often also designed for a particular stage of the wafer processing such as any one of the following: bare wafer, photolithography, active topography, metal interconnect, etch, chemical mechanical polish (CMP), final passivation, and the like. As a result, tools are not interchangeable from line to line, from stage to stage, or for different steps—and this is disadvantageous for users.

Traditionally, one semiconductor process tool includes one or more process units but is only equipped with one wafer stage, one robot arm, and one loading port, and the process tool is assigned to process wafers carrying or not carrying metal thereon. The metal carried on the wafer may be for serving as connects, vias, or plugs. If the wafer has metal, such as copper, nickel, and cobalt, or metal silicide, such as nickel silicide, formed thereon and get contact with the components of the process tool, the process tool may be contaminated with the metal. Thus, a plurality of process tools may be allotted to separately process wafers having and not having metal thereon to prevent cross contamination. If the process tool used to process wafers with metal formed thereon, especially on the backside of the wafer, is then intended to switch to process a wafer without the metal formed thereon, the process tool must be cleaned enough to remove the metal contaminant residing therein, for preventing the later wafers to be processed from a cross-contamination. Referring to FIG. 1, after cleaning, the process tool still needs to do be analyzed by extra total reflection x-ray fluorescence spectroscopy (TXRF), a particle test, or an induced couple plasma (ICP)—mass test to insure that the cleaning level is acceptable for the later wafer to be processed. For example, the content of Ni or Cu must be less than, for example, 1010 atoms/cm². Otherwise, several clean control wafers may be run in the tool to carry the metal particles or atoms away, and the cleaning test will be carried out again. The cleaning process and the leaning test will be circulated until the cleaning level is acceptable. As a result, it is time-consuming for each transition of the process for metal wafers to non-metal wafers. A new tool may be purchased to dedicate to a certain kind of wafers and thus metal wafer and non-metal wafer will be processed in separated tools; however, this will lead to lower utilization rate and be not economical.

Therefore, a novel semiconductor process tool is needed to process the wafers carrying contaminating material and not carrying contaminating material without trouble and time-consuming transition.

### SUMMARY OF THE INVENTION

An objective of the present invention is to provide a semiconductor process tool with dedicated wafer stages for receiving wafers having or not having contaminating material formed thereon, respectively, to prevent cross contamination.

In accordance with one aspect of the present invention, the semiconductor process tool comprises a first semiconductor process unit, a first wafer stage approximating to the first semiconductor process unit for receiving a first wafer thereabove and movable into the first semiconductor process unit, and a second wafer stage approximating to the first semiconductor process unit for receiving a second wafer thereabove and movable into the first semiconductor process unit. The first wafer carries contaminating material, and the second wafer does not carry the contaminating material.

In accordance with another aspect of the present invention, the semiconductor process tool comprises a semiconductor process unit, a first wafer stage in the semiconductor process unit for receiving a first wafer thereabove, and a second wafer stage in the semiconductor process unit for receiving a second wafer thereabove. The first wafer carries contaminating material, and the second wafer does not carry the contaminating material.

In accordance with still another aspect of the present invention, the semiconductor process tool comprises a first semiconductor process unit, a first wafer stage approximating to the first semiconductor process unit for receiving a first wafer thereabove and movable into the first semiconductor process unit, a second semiconductor process unit, and a second wafer stage approximating to the second semiconductor process unit for receiving a second wafer thereabove and movable into the second semiconductor process unit. The first wafer carries contaminating material, and the second wafer does not carry the contaminating material.

In the semiconductor process tool according to the present invention, the wafers carrying or not carrying contaminating material can be processed in a same process unit through different stages, robots, and load ports without cross contamination. Therefore, no transit time for preparation of a clean chamber is lost, tool utilization rate is enhanced, and risk of cross contamination is minimized.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a conventional transition from a metal tool to a non-metal tool;

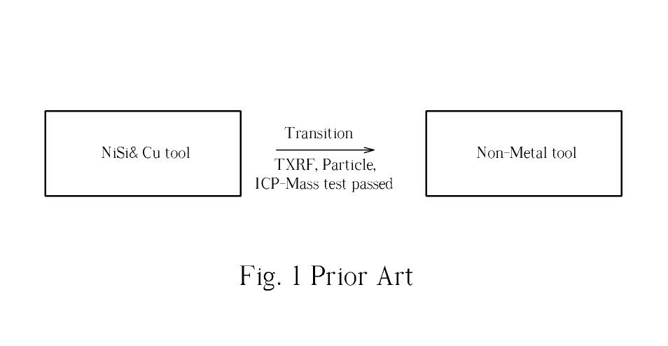

FIG. 2 shows a schematic diagram illustrating an embodiment of a semiconductor process tool according to the present invention;

FIG. 3 shows a schematic diagram illustrating another embodiment of a semiconductor process tool according to the present invention;

FIG. 4 shows a schematic diagram illustrating still another embodiment of a semiconductor process tool according to the present invention; and

FIG. 5 shows a schematic diagram illustrating further another embodiment of a semiconductor process tool according to the present invention.

### DETAILED DESCRIPTION

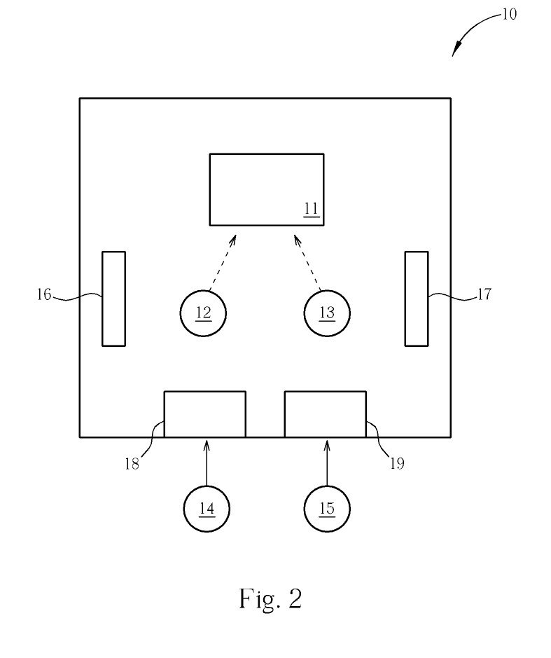

Please refer to FIG. 2 showing a schematic diagram illustrating an embodiment of a semiconductor process tool according to the present invention. The process tool 10 includes a first semiconductor process unit 11, a first wafer stage 12 and a second wafer stage 13. The first wafer stage 12 and the second wafer stage 13 are disposed to approximate to the first semiconductor process unit 11 and are used for receiving a first wafer 14 and a second wafer 15 thereabove, respectively. The first wafer stage 12 and a second wafer stage 13 are movable into the first semiconductor process unit 11 manually or automatically, for example, by gliding, for the loaded wafer to be processed in the process unit. The first wafer 14 may carry contaminating material, such as metal or metal silicide, and more specifically, nickel, cobalt, copper, or nickel silicide in a form of plugs, layers or lines formed on the wafer, especially on the backside of the wafer. The second wafer 15 does not carry the contaminating material. When the first wafer 14 received by the first wafer stage 12 is processed in the process unit 11, the second wafer stage 13 with the second wafer 15 may be stand-by outside the process unit. Because portions of the process tool other than the first wafer stage do not contact with the first wafer 14, the second wafer 45 can be sent in the process unit 11 by the second wafer stage 13 through a different path to be processed immediately after the first wafer 14 is transferred out of the process unit 11. Through the separate dedicated transferring paths for the two kinds of wafers to reach the semiconductor process unit 11, a cross contamination will not occur.

The process tool 10 may further include two robot arms 16 and 17 with chucks (not shown) thereon for transfer of the wafers. The process tool 10 may further be in a form of a closed space and include two load ports 18 and 19 for entry of the wafers into the process tool 10. Semi-auto or automatic load ports are available. The robot arm 16 and the load port 18, if included, are dedicated to the wafer 14 for the transferring. The robot arm 17 and the load port 19, if included, are dedicated to the wafer 15 for the transferring. Thus, the contamination source existing on the backside of wafers can be isolated by the dedicated robot arms, stages, and load ports to form isolated transfer paths, and thus the cross contamination of wafers processed in the process tool 10 is prevented.

The semiconductor process unit 11 may be an inspection unit, such as an ellipsometer, an optical microscope, an atom force microscope, a scanning electronic microscope, or the like. The semiconductor process unit 11 also may be a lithography unit or a chemical vapor deposition (CVD) unit, such as a tungsten chemical vapor deposition (WCVD) unit, a sub-atmospheric chemical vapor deposition (SACVD) unit, or the like. The semiconductor process unit 11 also may be a coating unit, such as a spin coater, or the like. The semiconductor process unit 11 also may be a physical vapor deposition (PVD) unit. Such semiconductor process unit does not contact directly with wafers to be processed. In one embodiment of the present invention, the process tool includes two wafer stages, one is utilized to dedicate to a category of wafers carrying contaminating material thereon, and the other is utilized to dedicate to a category of wafers not carrying contaminating material thereon, and thus the cross contamination of wafers processed in the process tool 10 is prevented.

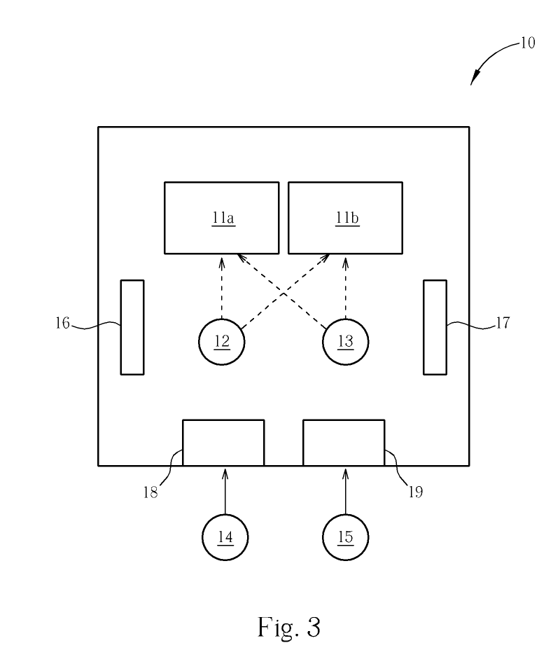

Please refer to FIG. 3 showing a schematic diagram illustrating another embodiment of a semiconductor process tool according to the present invention. The process tool 10 includes a first semiconductor process unit 11a as well as a second semiconductor process unit 11b, a first wafer stage 12, and a second wafer stage 13. The process tool 10 includes more than one process unit, and thus the processes may be carried out more conveniently and economically. The two semiconductor process units 11a and 11b may be the same of different. The first wafer stage 12 and the second wafer stage 13 are disposed to approximate to the first semiconductor process unit 11a and the second semiconductor process unit 11b, and are used for receiving a first wafer 14 and a second wafer 15 thereabove, respectively. The first wafer stage 12 and a second wafer stage 13 may be each movable into the first semiconductor process unit 11a and the semiconductor process unit 11b manually or automatically, for example, by gliding, such that the loaded wafer can be processed in the process unit. The first wafer 14 may carry contaminating material on the backside. The second wafer 15 does not carry the contaminating material. Through the dedicated transferring path for the wafers to reach the semiconductor process unit 11a or 11b, a cross contamination will not occur.

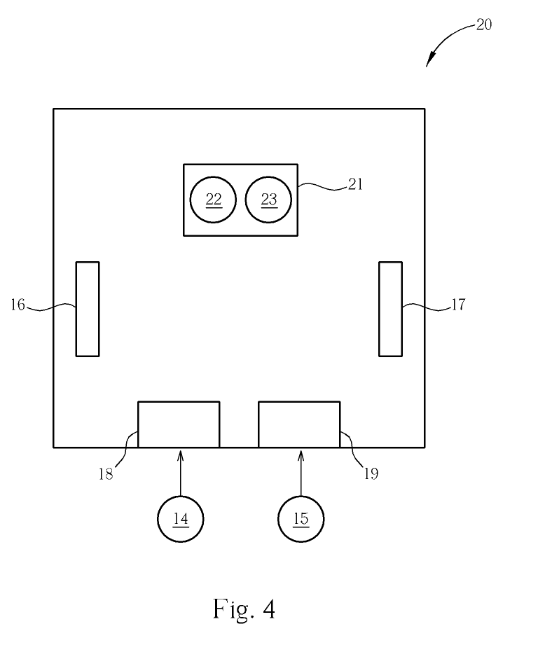

Please refer to FIG. 4 showing a schematic diagram illustrating another embodiment of a semiconductor process tool according to the present invention. The process tool 20 includes a semiconductor process unit 21, a first wafer stage 22, and a second wafer stage 23. The first wafer stage 22 and the second wafer stage 23 are disposed in the semiconductor process unit 21 for receiving a first wafer 14 and a second wafer 15 thereabove, respectively. The first wafer 14 may carry contaminating material, and the second wafer 15 may not carry the contaminating material. Similarly to the process tool 10, the process tool 20 may further include two robot arms 16 and 17 with chucks (not shown) thereon to load and unload the wafers onto and off the wafer stages 22 and 23. The process tool 20 may further be in a form of a closed space and include two load ports 18 and 19 for entry of the wafers into the process tool 20. The robot arm 16 and the load port 18, if included, are dedicated to the wafer 14 for the transferring. The robot arm 17 and the load port 19, if included, are dedicated to the wafer 15 for the transferring. Thus, the cross contamination of wafers processed in the process tool 20 is prevented.

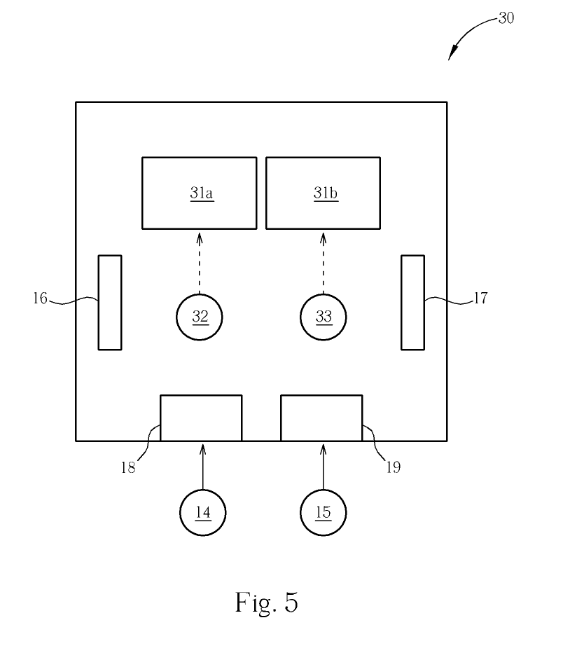

Please refer to FIG. 5 showing a schematic diagram illustrating further another embodiment of a semiconductor process tool according to the present invention. The process tool 30 includes a first semiconductor process unit 31a, a second semiconductor process unit 31b, a first wafer stage 32, and a second wafer stage 33. The first wafer stage 32 is disposed to approximate to the first semiconductor process unit 31a and is used for receiving a first wafer 14 thereabove. The first wafer stage 12 is movable into the first semiconductor process unit 11 for the loaded wafer to be processed in the process unit. The second wafer stage 33 is disposed to approximate to the second semiconductor process unit 31b and is used for receiving a second wafer 14 thereabove. The second wafer stage 33 is movable into the second semiconductor process unit 31b for the loaded wafer to be processed in the process unit. The first wafer 14 may carry contaminating material and the second wafer 15 may not carry the contaminating material. Through the dedicated transferring paths respectively for the wafers to reach the semiconductor process units 31a and 31b, a cross contamination will not occur. Similarly to the process tool 10, the process tool 30 may further include two robot arms 16 and 17 with chucks (not shown) thereon to load or unload the wafers onto or off the wafer stages 32 and 33, and further two load ports 18 and 19 for entry of the wafers into the process tool 30. The robot arm 16 and the load port 18 are dedicated to the wafer 14 for the transferring. The robot arm 17 and the load port 19 are dedicated to the wafer 15 for the transferring. Thus, the cross contamination of wafers processed in the process tool 30 is prevented.

Furthermore, the semiconductor process tool according to the present invention may include a plurality of process units, that is, two or more, and some of them are dedicated to a contaminating stage, other are dedicated to a non-contaminating stage; thus the cross contamination is alleviated or prevented.

Compared to the conventional techniques, the present invention provides a semiconductor process tool, in which the wafers carrying or not carrying contaminating material can be processed in a same process unit but through separated stages, robots, and load ports. For example, in general, a metrology tool is destructive, non-contact to wafers, no byproduct, and the like. By dedicating stages, load ports, robot arms and chucks of a metrology tool respectively to transferring wafers carrying and not carrying metal thereon, that is, transferring the wafers through separate transportation paths, the wafers can be mixed run in the same process unit in the metrology tool while not contaminated each other. Therefore, cross contamination is avoided. For using the semiconductor process tool according to the present invention, there are advantages that no transit time is lost, tool utilization rate is enhanced, and risk of cross contamination is minimized. Furthermore, by utilizing the semiconductor process tool according to the present invention, fab capacity can be calculated by chambers, no matter that the process tool is a front-end tool or backend tool. The capacity loss due to the transition of BEOL to FEOL procedure for a single machine can be reduced. The current fab working model will not be influenced using such process tools.

All combinations and sub-combinations of the above-described features also belong to the present invention. Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A semiconductor process tool, comprising:
a first semiconductor process unit;
a first wafer stage approximating to the first semiconductor process unit for receiving a first wafer thereabove and movable into the first semiconductor process unit, wherein the first wafer carries contaminating material; and
a second wafer stage approximating to the first semiconductor process unit for receiving a second wafer thereabove and movable into the first semiconductor process unit, wherein the second wafer does not carry the contaminating material.

2. The semiconductor process tool of claim 1, wherein the contaminating material comprises metal or metal silicide.

3. The semiconductor process tool of claim 2, wherein the metal comprises nickel, cobalt, copper, or nickel silicide.

4. The semiconductor process tool of claim 1, further comprising two robots and chucks for transferring the first wafer and the second wafer onto or off the first wafer stage and the second wafer stage, respectively.

5. The semiconductor process tool of claim 1, further comprising two load ports for entry of the first wafer and the second wafer into the first semiconductor process tool, respectively.

6. The semiconductor process tool of claim 1, further comprising a second semiconductor process unit approximating to the first wafer stage and the second wafer stage, wherein the first wafer stage and the second wafer stage are able to move into the second semiconductor process unit separately.

7. A semiconductor process tool, comprising:
a semiconductor process unit;
a first wafer stage in the semiconductor process unit for receiving a first wafer thereabove, wherein the first wafer carries contaminating material; and
a second wafer stage in the semiconductor process unit for receiving a second wafer thereabove, wherein the second wafer does not carry the contaminating material.

8. The semiconductor process tool of claim 7, wherein the contaminating material comprises metal or metal silicide.

9. The semiconductor process tool of claim 8, wherein the metal comprises nickel, cobalt, copper, or nickel silicide.

10. The semiconductor process tool of claim 7, further comprising two robots and chucks for transferring the first wafer and the second wafer onto or off the first wafer stage and the second wafer stage, respectively.

11. The semiconductor process tool of claim 7, further comprising two load ports for entry of the first wafer and the second wafer into the semiconductor process tool, respectively.

12. A semiconductor process tool, comprising:
a first semiconductor process unit;
a first wafer stage approximating to the first semiconductor process unit for receiving a first wafer thereabove and movable into the first semiconductor process unit, wherein the first wafer carries contaminating material;
a second semiconductor process unit; and
a second wafer stage approximating to the second semiconductor process unit for receiving a second wafer thereabove and movable into the second semiconductor process unit, wherein the second wafer does not carry the contaminating material.

13. The semiconductor process tool of claim 12, wherein the contaminating material comprises metal or metal silicide.

14. The semiconductor process tool of claim 13, wherein the metal comprises nickel, cobalt, copper, or nickel silicide.

15. The semiconductor process tool of claim 12, further comprising two robots and chucks for transferring the first wafer and the second wafer onto or off the first wafer stage and the second wafer stage, respectively.

16. The semiconductor process tool of claim 12, further comprising two load ports for entry of the first wafer and the second wafer into the semiconductor process tool.
